(19) United States
(12) Patent Application Publication
(10) Pub. No.: US 2002/0143961 A1
(43) Pub. Date: Oct. 3, 2002

(54) Access control protocol for user profile management

(76) Inventors: Eric Victor Siegel, New York, NY (US); Eleazar Eskin, New York, NY (US); Alexander Day Chaffee, San Francisco, CA (US); Zhi-Da Zhong, Elmhurst, NY (US)

Correspondence Address: LAHIVE & COCKFIELD, 28 STATE STREET, BOSTON, MA, 02109, US

(21) Appl. No.: 09/808,911

(22) Filed: Mar. 14, 2001

(51) Int. Cl. G06F 15/16

(52) U.S. Cl. 709/229; 709/230

(57) ABSTRACT

A customer profile access protocol with flexible access control capabilities is provided. The protocol facilitates secure and privacy enabled access to user profile data. The user profile data may be accessed by clients, such as other users, service providers and system administrators. The user profile data may be used by service providers and system administrators. The user profile data may be used by service providers to customize services provided to users. Permissions that control profile access may be established under user control. The user may specify different permissions for different grains of information within the user profile. For example, a first set of permissions may be associated with the entire user profile whereas a second set of permissions may be associated with a particular field in the user profile. Clients may be grouped such that permissions may be associated with a single group or combinations of groups specified by algebraic set operators.

### TECHNICAL FIELD

The present invention relates generally to information processing and more particularly to an access control protocol for user profile management.

### BACKGROUND OF THE INVENTION

Internet service providers and wireless service providers generally attempt to personalize service to users by maintaining information about the users in users' profiles. Each service provider separately stores data about each user, such as purchase history, preferences, billing information and the like. The service provider is responsible for gathering the data regarding the user and storing the data in a particular data format.

Unfortunately, there are several drawbacks to this conventional approach for customizing service for users. First, there is a great duplication of effort. Separate service providers may maintain the same information for a user, such as name, address and telephone number. This represents an inherent inefficiency and also may be cumbersome to the user because the user may be required to submit the same information to multiple service providers. In addition, each service provider has only a partial picture of user preferences (i.e., only the data gathered by the service provider). As such, each vendor may only partially personalize the service that is provided to the user. Third, the user typically has no control over the data that is stored by a service provider. In fact, most users do not even have access to the gathered data. Such data may be misused by unscrupulous service providers. Fourth, the data gathered for a user may be incorrect or out of date because information is not automatically propagated to all of the service providers; rather the proper information typically is only given to a select subset of the service providers.

### SUMMARY OF THE INVENTION

The present invention addresses the limitations of the conventional approach of obtaining and maintaining data regarding users by providing a user profile infrastructure. In accordance with this infrastructure, user profiles are stored and accessible via a central repository. The user profiles may contain information that is accessible by multiple service providers. As there is only a single user profile per user, changes need only to be made at a single location to ensure that the user profile is kept current. A user profile may be modified by the user. The user may have complete control over the user profile and may specify the information to be included in the user profile. The user may also have control over the permissions that specify what clients have permission to access information in the user profile. The permissions may specify the type of access that is provided to each client. Permissions may be specified not only for user profiles as a whole but also for individual fields within user profiles.

The infrastructure includes a protocol for facilitating the creation, management and access to the user profiles by clients. Clients may include service providers, system administrators and users. Account information may be maintained for each variety of client.

In accordance with a first aspect of the present invention, the method is practiced in an electronic device. In accordance with this method, a user profile is provided to hold information regarding a user. A set of permissions is established for the user profile. The set of permissions specifies who may access the user profile and may also specify what type of access is granted.

In accordance with another aspect of the present invention, user profiles are provided that hold information regarding users. The user profiles are accessible via a network. Groups of service providers can be defined. Each group contains a set of service providers. Access permission is granted through a selected one of the groups to facilitate service providers in the selected group accessing the information.

In accordance with a further aspect of the present invention, a user profile having various fields where at least some of the fields have associated permissions is provided in an electronic device. The permissions are set relative to a given service provider so as to prevent access to at least one selected field and to grant access to at least one given field in the user profile to support an anonymous transaction (i.e., a transaction where the user's identity is not revealed) between the given service provider and the user.

### BRIEF DESCRIPTION OF THE DRAWINGS

An illustrative embodiment of the present invention will be described below relative to the following drawings.

FIG. 1 depicts a number of components that are employed in the illustrative embodiment of the present invention.

FIG. 2 illustrates an exemplary environment for practicing the illustrative embodiment.

FIG. 3 illustrates different varieties of clients that may participate in the PMT protocol.

FIG. 4 illustrates an example of data stored within a user profile.

FIG. 5 illustrates the different granularities to which permissions may be attached in the illustrative embodiment.

FIG. 6 illustrates an example of a service provider hierarchy.

FIG. 7 is a flow chart illustrating the steps that are performed to generate a user profile.

FIG. 8 is a flow chart illustrating an example of the steps that are performed to support an anonymous transaction.

### DETAILED DESCRIPTION OF THE INVENTION

The illustrative embodiment of the present invention provides a user profile access protocol with flexible access control capabilities. The protocol includes operations to get and set the following: a user profile schema definition, user profile fields, user profile access permissions (on a per-field basis), groups that define what parties are granted permissions, group access permissions and permissions access permissions (i.e., “meta-permissions”).

The user profiles may be accessed by clients, such as administrators, users and service providers. The user profiles are especially well adapted for use with Internet service providers and wireless service providers. The protocol provides an approach for generating, modifying and accessing user preferences and other types of user information. Service providers may access this user profile information to customize services that are provided to customers.

The protocol specifies the interaction between a preference manager and a single client. It is presumed that there is a communication mechanism for transporting requests and responses of the protocol. The clients may communicate with the preference manager over a network, such as computer networks (like the Internet) or communications networks (like wireless networks). In general, the protocol requires a communications path between a preference manager and a client.

The PMT protocol controls access to each piece of data within a user profile by examining permissions associated with the data. Permissions may be associated with an entire user profile, or a field in the profile. Thus, the granularity of permissions may be variable with the smallest grain being that of a field. Permissions may be specified in terms of groups. In fact, permissions may be specified using a set algebra applied to groups. For example, a given user profile may be accessible by clients that are identified by the union of two groups. A group may be defined as a listing of clients (i.e., a listing of account I.D.'s where each client has an associated account I.D.'s) or in terms of other groups. The use of such groups allows data sharing within groups of service providers of the same category and other varieties of data sharing. Moreover, the groups readily accommodate a dynamic modification of clients that are given access to user profiles. For example, if a user grants access to a group of pizza vendors to the users phone number, the group of pizza vendors may be dynamically modified, and there is no need for the user to update the user profiles to include or exclude pizza vendors that have been added or removed from the group. The specification of the permissions automatically accounts for such changes.

The user profile may include service provider specific fields (i.e., a client specified schema). For example, a pizza vendor may have a field that specifies a favorite pizza for the user. The user profile may also contain more general information, such as the user's name, address and telephone number.

The protocol stipulates the semantics of each communication. For example, to get information regarding a user, the response to the request hinges on what permissions mean in the context. The protocol describes getting and retrieving the permissions as well as the specification of what information is stored for each user. The protocol further describes definitions of groups and accounts. The protocol seeks to provide a powerful infrastructure while maintaining simplicity.

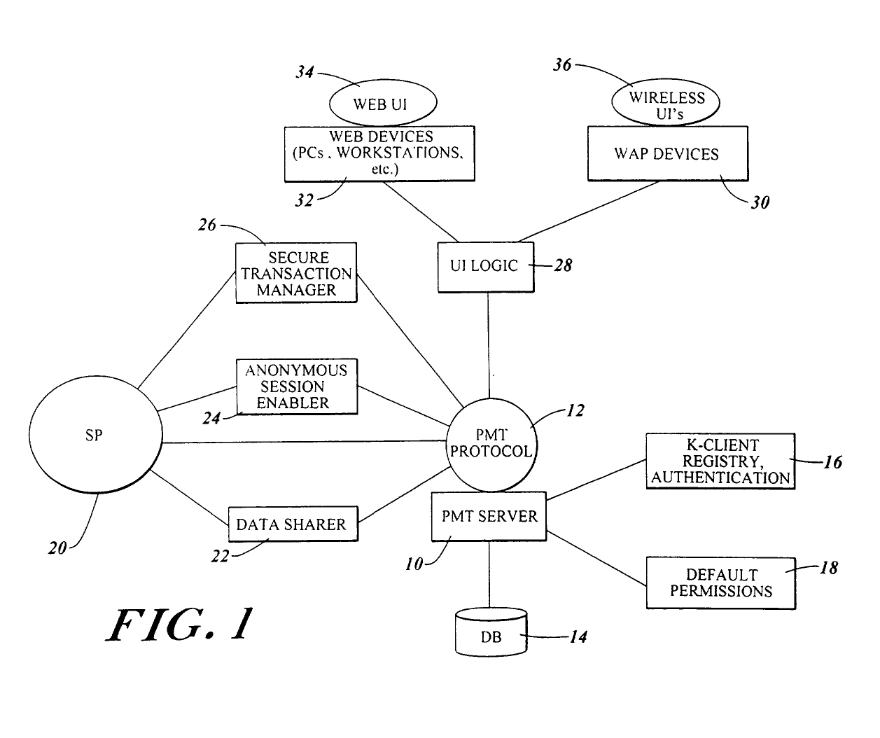

FIG. 1 depicts components employed in the illustrative embodiment of the present invention. A PMT server 10 is provided for facilitating transactions involving the user profiles stored in the database 14. The PMT server 10 is presumed to be a server process running on a computer system or on another intelligent electronic device. The PMT protocol 12 is supported by the PMT server 10, and transactions occur in accordance with the PMT protocol. It is presumed that clients also have support for the PMT protocol (e.g. they can formulate proper PMT requests). The PMT server 10 may execute an account manager 16 that maintains a registry of accounts for clients that seek access to the data within the database 14. As mentioned above, each account may represent a client user, such as a service provider or system administrator. The PMT server 10 may also hold a number of default permissions 18 that are assigned in the event that the user does not specify explicit permissions for data within the user profile. The database 14 holds user profiles, information regarding groupings of clients (such as service providers) and permissions information.

Service providers (SP) 20 may access the data within the database 14 by using the PMT protocol 12 to communicate with the PMT server 10. A data sharer facility 22 facilitates the exchange of information between a repository and another system (such as that maintained by a service provider) that stores some types of personal data. An anonymous session enabler facility 24 may enable a communication session with the PMT protocol to occur anonymously, as will be described in more detail below. A secure transaction manager 26 is provided to ensure that the communications between the service provider and the PMT protocol 10 take place in a secure fashion.

User interface logic 28 may be provided to allow users to communicate with the PMT server 10. It may be desirable for a user to be able to view the user profile and associated permissions as well as to modify the user profile permissions. For example, the PMT server 10 may provide a web page that allows a verified and authenticated user to review and modify the users user profile and associated permissions. The UI logic 28 facilitates such interactions between the users and the PMT server 10. As mentioned above, users may access and communicate with the PMT server 10 via web devices 32, that communicate over the Internet or over other computer networks via a web user interface 34. Examples of web devices include but are not limited to personal computers, Internet appliances, network computers and other types of devices that rely upon a web browser. Users may also communicate using wireless devices 30, such as cellular phones, personal digital assistants (PDAs), and intelligent pagers, via a wireless UI 36. The wireless devices 30 may be wireless application protocol (WAP) devices 30 that employ WAP to communicate with the PMT server 10.

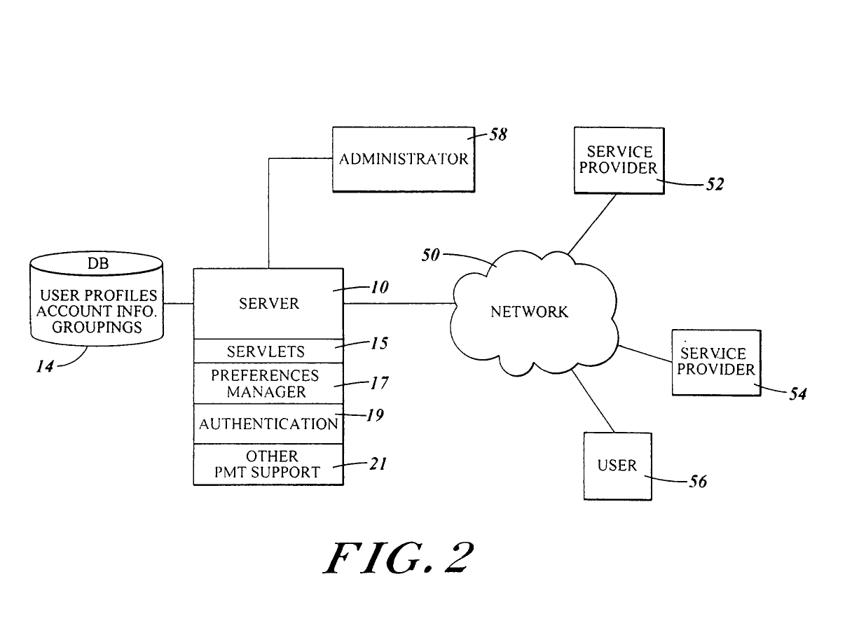

FIG. 2 shows an example of an environment in which the illustrative embodiment is practiced. The PMT server 10 is coupled with a network 50 (e.g. the Internet, a computer network or a communications network). Various service providers 52 and 54 have resources that are coupled via the network 50. The user 56 for which user profile is stored in database 14 may have access to the network 50. An administrator 58 may have direct access (i.e., may be directly cabled) to the server 10. The server 10 includes a preferences manager 17 that is responsible for maintaining the data within the user profiles. The server 10 also may include an authentication mechanism for authenticating both users and clients. More generally, other support for the PMT protocol 28 may be stored and run on server 10. The server may have a number of servlets 15 that assist in execution. The database 14 includes user profiles, account information and information regarding the groupings.

Those skilled in the art will appreciate that there need not be a single database; rather, multiple databases may be used or multiple copies of the database may be provided. Moreover, multiple PMT servers may be provided to enhance availability, to provide load balancing and to decrease latency of transactions.

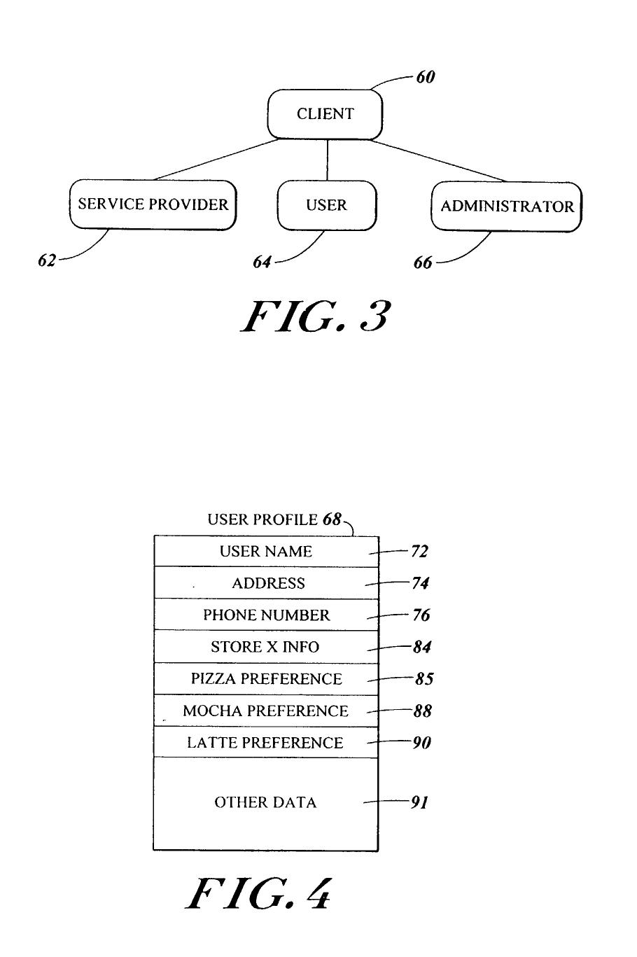

As mentioned above, clients may take many forms. FIG. 3 shows that a client 16 may be a service provider 62. The service provider provides a service via a network, such as a wireless network or computer network. The service provider may be an Internet service provider (ISP) which customers access via the Internet. A client may be a user 64 or a system administrator 66.

The information in the user profile may be stored hierarchically. Those skilled in the art will appreciate that the data need not be stored in records; rather other data types are acceptable. For example, all data may be encapsulated in objects in some instances. The objects may be hierarchically organized. The data need not be hierarchical but may be, instead, non-hierarchical.

FIG. 4 shows an example of a portion of a user profile 68. The data stored within the user profile 68 includes user name 72, address 74 and telephone number 76. Information 84 for a store (“store x”) may be stored in the user profile 68. A pizza preference 85 for the user may also be stored in the user profile 68. Similarly, a coffee preference regarding a cafe latte 90 may be provided along with a coffee preference regarding a cafe mocha 88. Other data 91 may also be stored in the user profile 68.

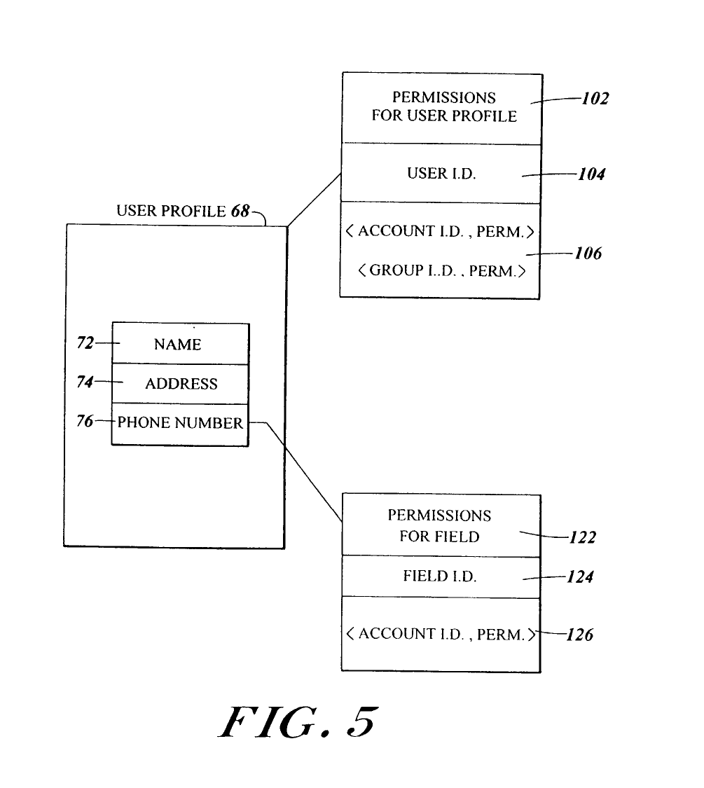

The granularity to which permissions may be specified for the user is variable. The permissions may be associated with an entire user profile or with a field within the user profile. When different data structures are used, the granularity may change to suit the particular data structures used. FIG. 5 illustrates an example of such permissions. A user profile 68 includes a name field 72, an address field 74 and a phone number field 76. Permissions are stored for the user profile 68, and permissions are stored for the phone number field 76. The permissions 102 for the user profile 68 include a user I.D. 104 that specifies a unique identifier for the user associated with the user profile 100. The permissions 102 also specify the account-I.D. and access rights 106 for each of the clients or groups that have access to the user profile. Lastly, permissions 122 are stored for the phone number field 76. A field-I.D. 124 uniquely identifies the phone number field 76. A listing 126 of those who have access to the telephone number field is provided.

Permissions also specify the type of access that is granted to a client. These permissions include write access, which enables a client to write and read data from the associated unit of data, and read access which allows a client to read data from the associated data unit but not write data. The permissions also include delete access. Delete access allows a client to delete data within the associated data unit. Availability access enables a client to determine whether the data is available or not. Permissions additionally include permission write access which enables a client to write permissions values.

The protocol facilitates the definition of groups of clients. Groups are especially well adapted for grouping service providers. Groups allows service providers to share information and for permissions to be associated with groups rather than individual clients.

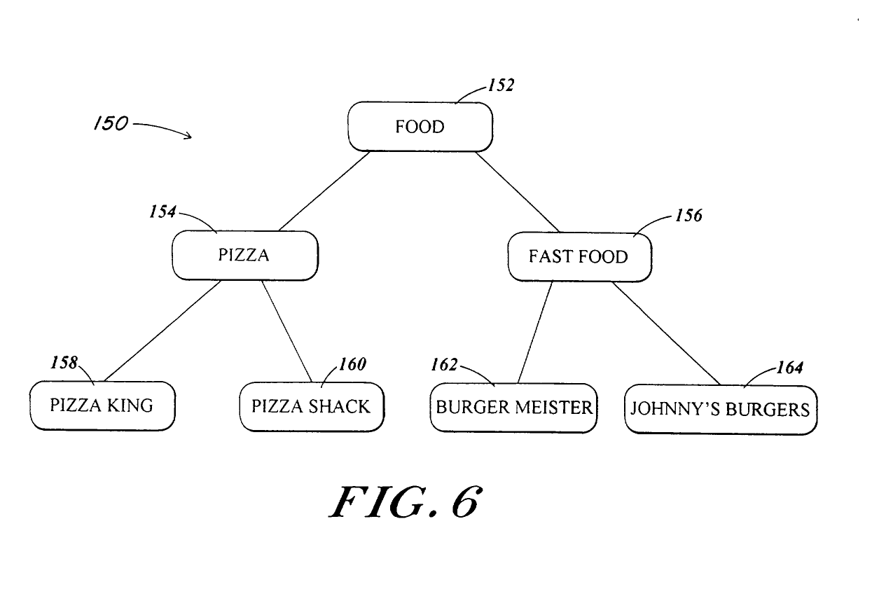

Groups may be organized hierarchically, such as shown in FIG. 6. FIG. 6 shows a hierarchy 150 of service provider groups. A food group 152 encompasses service providers that are in the food industry. The food group 152 may include a subgroup 154 for pizza vendors and a sub group 156 for fast food vendors. The pizza vendor group 154 may include the Pizza king service provider 158 and the Pizza Shack service provider 160. Similarly, the fast food group 156 may include the Burgermeister service provider 162 and Johnny's Burgers 164.

As mentioned above, account information is maintained for each client, and each client is identified by a unique account I.D. Additional information such as billing information and other relevant information may be maintained for the account.

A group is either a collection of accounts or a set algebraic expression on other groups. In particular, the algebraic expressions use set algebra operators of union and intersection and set difference. Groups that are defined by a set algebraic expressions are evaluated dynamically. If the groups change, the resulting value of expressions change dynamically.

The protocol is a response/request protocol. In other words, a request is submitted and a response is returned. A number of different parameters are used in requests. These parameters include account-I.D., which provides an alphanumeric string that identifies a client. Another parameter is a group-I.D. that uniquely identifies a group. Similarly, there are field I.D.'s that identify fields. Permission types include read, write, availability and delete. Additional permissions include permission read and permission write.

The protocol specifies that there may be a need for a log-in before a session begins. The client seeking to initiate a session with the PMT server 10 may be required to provide an account I.D. and password.

The protocol specifies a number of operations that may be associated with data stored within the database 14. These operations include the following:

getNodeData

setNodeData

deleteProfileNode

getPermission

setPermission

query.

The getNodeData operation is passed parameters that identify the information user profile that is sought. This information may include the user-I.D. and field-I.D. In contrast, when a field is sought, the user-I.D., and field-I.D. must all be specified. If the requested client has the appropriate permissions, the get request results in the returning of the desired data to the client. If not, the client receives an appropriate message indicating that the request was denied.

The setNodeData operator enables a client to set a value within a user profile. The input parameters may include user-I.D., field-I.D. and value to be set.

The deleteProfileNode operation enables a client to delete a field, or user profile. The input parameters specify the field or user profile. The client must have the appropriate delete access permissions.

The getPermission operation enables a client to obtain permissions that are associated with a field or user profile. The field or user profile are specified by the input parameters.

The setPermission operator enables a client to set permissions for a field or user I.D. The set permissions may be set for an entire group with this command.

The query operation returns a list of user-ID's that match the query criteria.

The protocol also specifies operations that may be submitted in requests for managing groups. These operations include:

getMembers

newGroup

defineGroup

deleteGroup

getGroupPermission

setGroupPermission.

The getMembers operator allows a client to obtain a list of members within a group that is identified by group-I.D. input parameter.

The newGroup operator enables a client to define a new group. The input parameters include a group name as well as a textual description. The client is returned a group-I.D. and/or acknowledgment that a new empty group has been defined.

The defineGroup operator defines members of a group that have been created using the newGroup operator. Input parameters include a group-I.D. and any algebraic set operators that are required to appropriately define the group.

The deleteGroup operator deletes a group from the database 14. The input parameter specifies the group-I.D. of the group.

The getGroupPermission operator obtains permissions for a particular group.

The setGroupPermission operator allows the permissions for a specified group to be set.

The protocol also includes operators for administration of database schemas within the user profile. As mentioned above, service providers and other clients may define schemas for data stored within the user profile. The operations include the following:

addField

deleteField

setSchemaPermission.

The addField operator enables a new field to be added to the schema. The input parameters identify the new field to be added.

The deleteField operator deletes a field in as identified by the field-I.D.

An API may be defined to enable clients to call the operations specified by the PMT protocol.

One of the benefits of the illustrative embodiment is it allows a user to control the user profile. The user may use the UI logic 28 to access the PMT server 10. FIG. 7 is a flow chart illustrating the steps that are performed to generate a user profile. Information about the user is obtained (see Step 170 in FIG. 7). The user may be prompted via the UI logic 28 to enter information to be incorporated into the user profile. Alternatively, information may be obtained by the data sharer facility 22 or from other sources to create the user profile. This information is then stored in the user profile along with the associated permissions (see Step 132 in FIG. 7). The user may have the ability to explicitly set the permissions or default permissions 18 may be applied.

The illustrative embodiment facilitates the ability to perform anonymous transactions by appropriately setting the permissions. FIG. 8 is a flow chart illustrating the steps that may be performed to facilitate such anonymous transactions. Initially, at least one unit of data may have a permissions set to block access (step 180 in FIG. 8). This unit of data may be, for example, a field. Multiple such units may be blocked by denying access to such units to selected clients. At least one unit of data in the user profile is configured so that the permissions permit at least one client to access the field (step 182 in FIG. 8). The transaction may then be performed. The transaction may be performed anonymously by, for example, blocking access to the user's name and other identifying information. For example, access may be blocked to the user's credit card number or address or phone number. Similarly, in some cases, access may be granted strictly to a payment mechanism, such as a credit card or bank account number.

One potential application is in the area of medical records. A patient may be identified by a patient I.D. that is not readily trackable to the named patient. Access to fields in the user profile that will reveal the identity of the patient are blocked. The medical records may then be sent securely over a network connection stamped with the patient I.D.

While the present invention has been described with the reference to an illustrative embodiment thereof, those skilled in the art will appreciate the various changes in form and detail may be made without departing from the intended scope of the present invention as defined in the appended claims.

1. In an electronic device, a method, comprising the steps of:
providing a user profile holding information regarding a user;
establishing a first set of permissions for the user profile, wherein said first set of permissions specifies who may access the user profile;
establishing a second set of permissions for a selected sub-division of the user profile, wherein said second set of permissions specifies who may access the sub-division; and
wherein in order for a party to access the selected sub-division, the party must be specified by the first set of permissions as having access to the user profile and must be specified by the second set of permissions as having access to the selected sub-division.

2. The method of claim 1, wherein the sub-division is a field.

3. The method of claim 1, wherein the first set of permissions specifies what type of access to the user profile is granted to those who may access the user profile.

4. The method of claim 4, wherein at least one party is granted read access to the user profile, indicating that the party may read information in the user profile.

5. The method of claim 4, wherein at least one party is granted write access to the user profile, indicating that the party may write information into the user profile.

6. The method of claim 4, wherein at least one party is granted availability access to the user profile, indicating that the party may find out whether the user profile is available.

7. The method of claim 4, wherein at least one party is granted delete access to the user profile, indicating that the user may delete information in the user profile.

8. The method of claim 1, wherein the second set of permissions specifies who may access the user profile.

9. The method of claim 1, wherein one of the first set of permissions and the second set of permissions contains a list of parties that may access the user profile and the sub-division, respectively.

10. The method of claim 1, wherein defined groups of parties are provided and wherein at least one of the first set of permissions and the second set of permissions specifies one of the groups as having access.

11. The method of claim 1, wherein the user specifies at least one of the first set of permissions and the second set of permissions.

12. The method of claim 1, wherein at least one of the first set of permissions and the second set of permissions is established by default.

13. The method of claim 1, further comprising the step of establishing a third set of permissions for an additional one of the sub-divisions in the user profile, wherein said third set of permissions specifies who may access the additional sub-division.

14. The method of claim 12, wherein the sub-division of the user profile are organized hierarchically and wherein the sub-division contains the additional subdivision.

15. The method of claim 1, wherein defined groups are provided and wherein at least one of the first set of permissions and the second set of permissions specifies who may have access as an access set, said access set resulting from a set algebraic operation performed on at least two of the groups.

16. A method, comprising the steps of:
providing user profiles that hold information regarding users and are accessible via a network;
specifying groups of service providers for providing services to the users, each group containing a set of service providers; and
granting access permission for authorized information in a selected user profile to a selected one of the groups so that the service providers in the selected group may access the authorized information.

17. The method of claim 16, wherein the service providers in the selected group all provide a common category of service.

18. The method of claim 16, wherein at least one group contains other groups that constitute subsets of the group, and said groups containing logically related service providers.

19. The method of claim 16, wherein the user profiles are accessible via a centralized repository and wherein the authorized information in the user profile may be accessed by service providers that did not directly solicit the accessible information from the user.

20. In an electronic device, a method, comprising the steps of:
providing a user profile having various fields, wherein at least one of said fields has associated permissions;
setting the permissions relative to a given service provider so as to prevent access to at least one selected field and grant access to at least one given field in the user profile so as to support an anonymous transaction between the given service provider and the user by withholding an identity of the user.

21. The method of claim 20, wherein the user profile contains a name field holding a name of the user and wherein the selected field is the name field.

22. The method of claim 20, wherein the user profile contains an address field holding an address field holding an address of the user and wherein the selected field is the address field.

23. The method of claim 20, wherein the permissions are set to block access to multiple ones of the fields by the given service provider.

24. The method of claim 20, wherein the user profile contains a payment field holding information regarding a payment mechanism and wherein the given field is the payment field.

25. The method of claim 20, wherein the user profile contains a credit card field holding credit card number and wherein the select field is a credit card field.

26. In an electronic device, a method, comprising the steps of:
providing a user profile holding information regarding a user in fields;
providing a protocol that enables the getting and setting of the following:
(i) fields in the user profile;
(ii) access permissions for the fields in the user profile;
(iii) members of groups that have access permissions to selected ones of the fields in the user profile;
(iv) group access permissions that specify access information regarding groups;
(v) permissions access permissions that specify permissions for the access permissions; and
(vi) a schema definition for the user profile.
